(19) United States
(12) Patent Application Publication
(10) Pub. No.: US 2008/0190838 A1
(43) Pub. Date: Aug. 14, 2008

(54) Bailing Apparatus

(75) Inventor: Angus Reardon, New South Wales (AU)

Correspondence Address: BROOKS KUSHMAN P.C., 1000 TOWN CENTER, TWENTY-SECOND FLOOR, SOUTHFIELD, MI, 48075, US

(73) Assignee: Angus Reardon, New South Wales (AU)

(21) Appl. No.: 10/595,106

(22) PCT Filed: Aug. 16, 2004
(86) PCT No.: PCT/AU04/01097

§ 371 Date: Feb. 15, 2006

(30) Foreign Application Priority Data
Aug. 15, 2003 (AU) 2003904342

(51) Int. Cl. B01D 29/00

(52) U.S. Cl. 210/416.1

(57) ABSTRACT

A bailing or liquid extraction apparatus for removing liquid from a body of liquid, such as, pools, ponds, water holes, creeks, rivers, excavated hole, flooded areas and natural or artificial reservoirs comprises a hollow body (16) which has an arcuate bottom surface which in use retains a pump inlet (14) within an interior of the hollow body, said hollow body having one or more openings (19) for ingress of liquid.

### FIELD OF INVENTION

This invention is concerned with removing liquid, such as water, from bodies of water such as, pools, ponds, water holes, creeks, rivers, excavated holes, flooded areas and natural or artificial reservoirs. In particular, but not exclusively, the invention relates to a portable bailing apparatus that can remove the last remaining litres of water from water holes, reservoirs, pools and flooded areas of minimum depth and with variable bed characteristics. This invention may also apply to removal of other liquids, such as oil or chemicals.

### BACKGROUND OF THE INVENTION

Droughts have a major impact on a nation's economy. Of all the climatic phenomena to afflict Australia, drought is probably the most economically costly, the economic problems predominantly resulting from crop failure and livestock loss. Droughts can extend over several years, relieved by only brief transitory rains. Drought relief for farmers and agricultural communities is restricted to times of exceptional circumstances and economic relief only is available for droughts of atypical length or severity. In third world countries, such as Ethiopia, Sudan, Botswana and Mozambique, drought repeatedly and ultimately results in malnutrition, famine and prevents economic development.

Water is the most vital resource during drought. In drought conditions, removing water from water holes, digging new water holes or deepening existing springs can sometimes provide an adequate supply of water for livestock or crops. However, extraction of usable water from shallow bodies of water such as waterholes, creeks, reservoirs, springs, wells and pools is very difficult. Most pump devices leave approximately a foot of valuable water behind and generally this water is muddy or silty and often inaccessible from dry or solid land. At present the only way of accessing this water is by wading out through the mud or silt to the shallow pools of water and bailing out the water using a container such as a bucket. This is a very inefficient, inconvenient and unsafe method. Therefore in remote areas or in less developed sections of the world there is a need for a manual, portable and maneuverable bailing apparatus that can extract the last litres of water from a body of water, does not require connection to a mains power source and can be operated by one person.

The prior art focuses on water pumps designed for fire-fighting (U.S. Pat. Nos. 4,553,902 and 5,419,497), swimming pools (U.S. Pat. No. 5,655,246) or removing oil from bodies of water (GB Patent No. 2,269,329). The prior art pump apparatus are generally sophisticated devices comprising a support stand, motor-driven pump, float, water conduits and supporting members. These apparatus require a power supply, are expensive to manufacture, not easily carried to remote areas and not suitable for extracting water from shallow, muddy or silty bodies of water.

French Patent No. 2,429,378A describes a liquid extraction device for the extraction of oil or liquid petroleum contained in a tank of a ship. The extraction device floats on the surface of the oil or liquid petroleum and comprises a floating vacuum head in flow communication with a first pump. The floating vacuum head has openings for drawing up liquid which is passed through the first pump located on the surface of the liquid. The liquid is then drawn by suction to a second pump located outside the tank.

This device is considered to be extremely complicated in construction requiring two pumps in flow communication with each other.

U.S. Pat. No. 5,669,323 in the name of Aaron Pritchard describes an automatic battery-operated bailer that can remove water from floor of boats, such as canoes. The bailer comprises a pump, flexible hose, water conduit means and battery box, and the battery box is secured to the interior of the boat. This bailer is designed specifically for boats and would not be suitable for use in muddy or silty waterholes because the pump means would sink into the bed of the waterhole.

GB Patent Number 1,020,712 in the name of John McColl describes a suction pump strainer for the drainage of shallow pools of water, in particular for the removal of nuisance water in collieries and civil engineering projects. It comprises a cylindrical casing, having a tubular member extending into the casing with an elliptical inlet opening and a strainer. The elliptical inlet opening is located in a base wall of the casing. The casing is also provided with perforations in a side wall to function as a strainer or filter. The tubular member is inclined at an acute angle relative to the base wall of the casing and has a water inlet for connection to a pump conduit.

The disadvantage of GB 1,020,712 is it is not designed for muddy or silty water bodies which can also be infested with weeds. This is because it has a bottom inlet aperture for ingress of liquid. The casing would also sink into a muddy water bed making it very difficult to maneuver and therefore limiting its usefulness because the base wall is flat and thus makes contact with the bottom of the water body. It is also considered that this apparatus will be inefficient in use because of turbulence and vortexing of the liquid within and above the casing, resulting in inefficient pumping and extraction of the liquid.

In summary, none of the above prior art apparatus are effective in use for extraction of water from a water body or from a shallow bed of liquid remaining in a water body. Also, the above prior art suffers from the deficiency of being complicated in construction.

### SUMMARY OF INVENTION

There is a need for a water extraction or bailing apparatus that addresses or at least ameliorates the problems encountered with the prior art and which is efficient and economic in use.

In one form, although it need not be the only or indeed the broadest form, the invention resides in a bailing apparatus designed for removing liquid from a body of liquid, said apparatus comprising a hollow body which has an arcuate bottom surface which in use retains a pump inlet within an interior of the hollow body, said hollow body having one or more openings located in the hollow body.

The hollow body may have any suitable shape but is preferably substantially spheroidal. More preferably it is ovoidal, and most preferably of a shallow ovoid shape as hereinafter described in the illustrated embodiment. Preferably, the hollow body in cross section has an elliptical shape.

Preferably, the hollow body is non-floatable.

The hollow body may have a plurality of spaced openings to facilitate water ingress, which may be arranged in a row about the mid section or mid part of the hollow body, which has the greatest diameter. More preferably, however, there is provided a single elongate opening in the ovoidal body about its central diameter. The width of the opening may be adjustable.

Preferably, the hollow body is comprised of two or more components which may be releasably attached to each other and there may be provided releasable attachment means to facilitate this. More preferably, the hollow body is comprised of two half or semi-components which are identical and attached to each other about the mid section or area of greatest diameter as shown hereinafter in the illustrated embodiment.

Any appropriate releasable attachment means may be used for this purpose such as bolts or elongate fasteners extending between appropriate sockets located on each component.

It is preferred that the hollow body comprises two components that are releasably attached to each other as described above because of the necessity of placing the pump inlet and associated conduit within the interior of the hollow body as shown hereinafter in the illustrated embodiment.

Preferably, one component is hingedly attached to the other component at adjacent respective ends of each component. This may be accomplished by an appropriate hinge means which connects one end of a component to an adjacent end of the other component.

There also may be provided retaining means for retaining a pump inlet within the hollow body and this may comprise one or more retaining ribs located on an internal surface of one or more, preferably each component. Such ribs may be one or a plurality of peripheral ribs, which may be circular or elliptical in shape surrounding the valve body in use. In another arrangement there may be one or more upright ribs on each component which engage with the valve body in use.

The pump inlet of the apparatus includes a hollow valve casing having a non-return valve or check valve. Preferably, the pump inlet in use is in flow communication with a pump located externally of the body of liquid. More preferably, the pump inlet is connectable to the pump by a hose and the hose is pivotally attached to the hollow body. Suitably, the pump inlet may include a strainer or filter.

Throughout this specification, “comprise”, “comprises” and “comprising” are used inclusively rather than exclusively, will be understood to imply the inclusion of a stated integer or group of integers but not the exclusion of any other integer or group of integers.

### BRIEF DESCRIPTION OF THE DRAWINGS

Reference may now be made to a preferred bailing apparatus of the invention as shown in the attached drawings wherein:

FIG. 1 is a side view of the bailing apparatus of the invention in use.

FIG. 2 is a more detailed side view of the bailing apparatus shown in FIG. 1.

FIG. 3 is an end view of the bailing apparatus shown in FIG. 1.

FIG. 4 is a plan view of one of the identical sections of the hollow body.

FIG. 5 shows the positioning of the pump inlet and the retaining means. FIG. 5A is a cross sectional view of the hollow body. FIG. 5B is a perspective view of the hollow body and pump inlet.

FIG. 6 shows the positioning of the pump inlet and alternate retaining means. FIG. 6A is a cross sectional view of the hollow body. FIG. 6B is a perspective view of the hollow body and pump inlet.

### DETAILED DESCRIPTION OF INVENTION

For the purposes of this invention, by “water body” is meant any body of water, such as creeks, springs, rivers, reservoirs, ponds, pools, waterholes, wells, excavated holes, tanks and flooded areas.

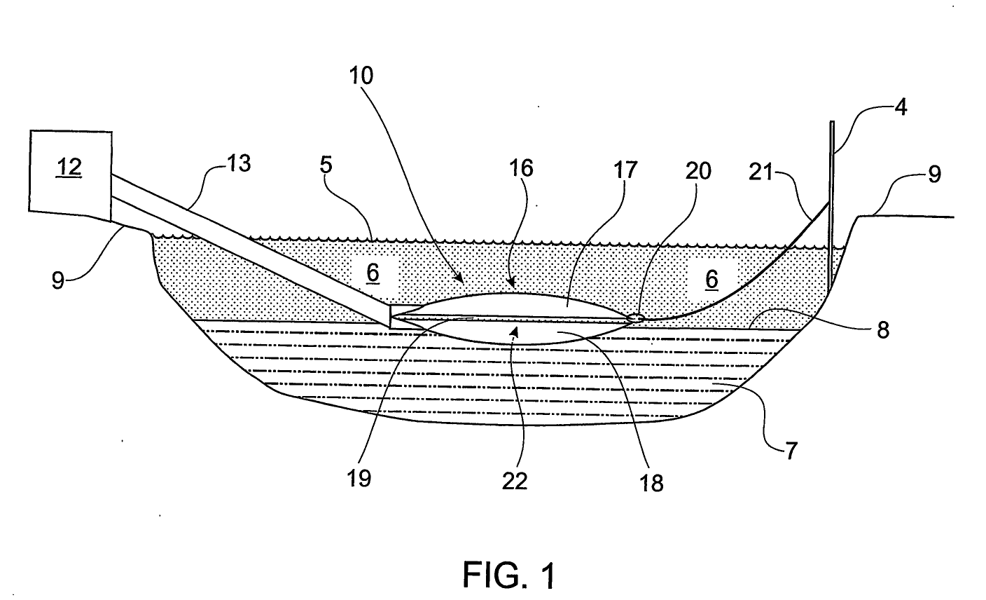

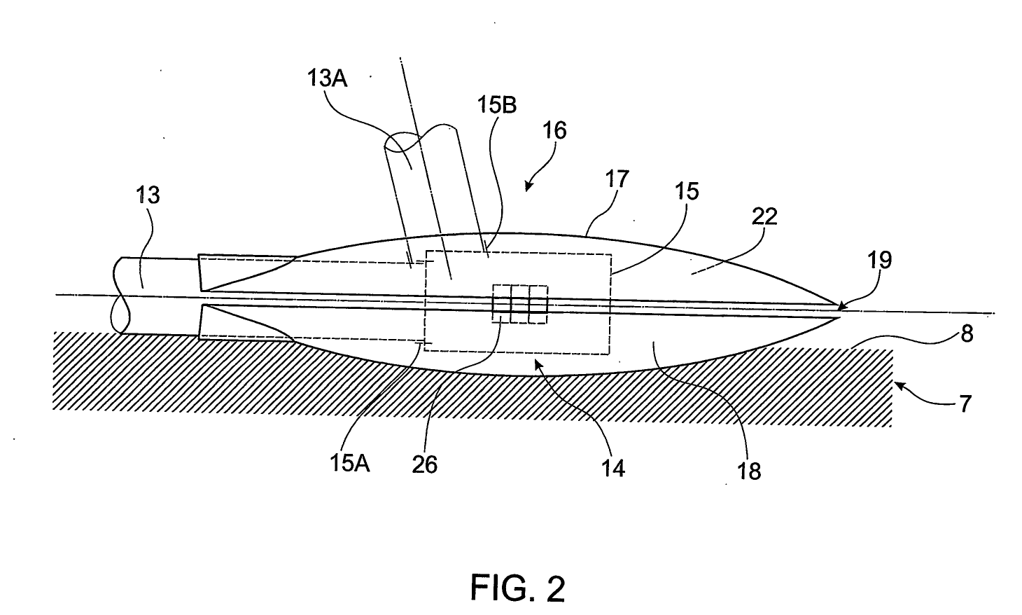

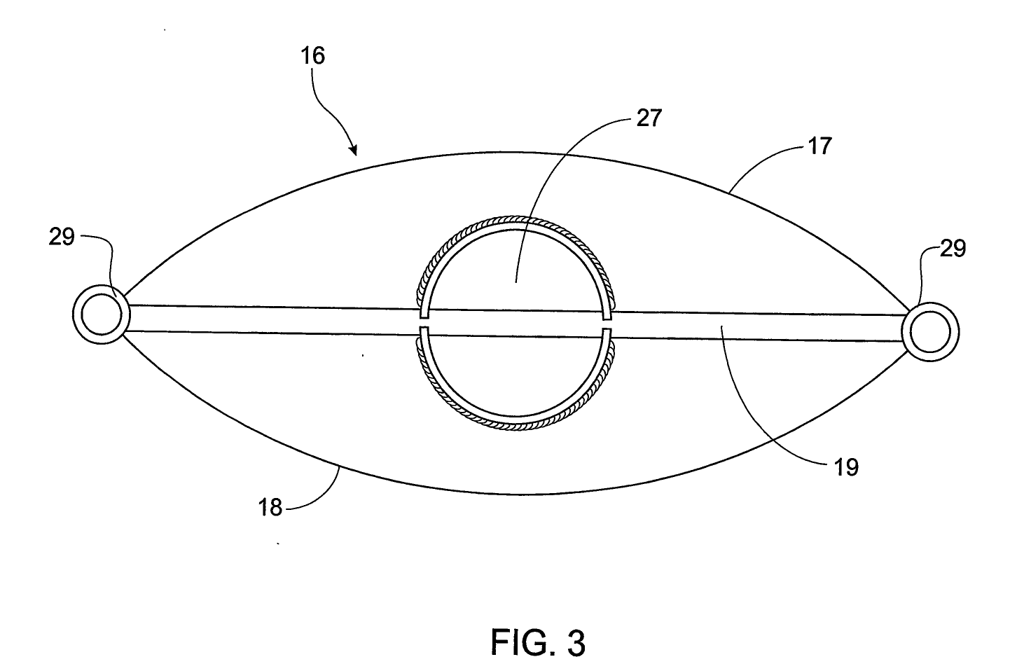

FIG. 1 shows a bailing apparatus 10 of the present invention in use in a water body 5. Body 16 of bailing apparatus 10 is resting on waterbed 8 above mud or silt 7 below water 6. Suction pump 12 of bailing apparatus 10 is placed on dry land 9 and is attached to body 16 by suction conduit or hose 13. Conduit 13 is attached to pump inlet 14, which comprises valve casing 15 and valve 26 (see FIG. 2). Valve casing 15 is located in a hollow interior 22 of body 16 and is surrounded by body 16. Conduit 13 enters body 16 through conduit aperture 27 (see FIG. 3). In use body 16 is pivotally attached to conduit 13.

Body 16 is releasably-attached to pole 4 by rope or tether 21. Tether 21 attaches to body 16 through an attachment means 20, such as a hook or collar.

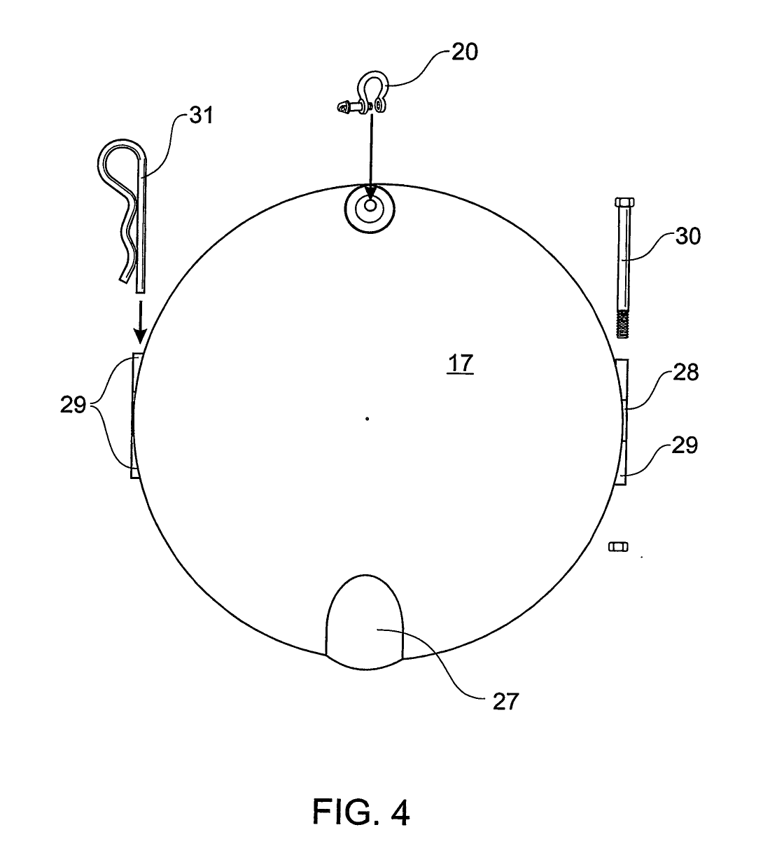

Body 16 has a shallow ovoidal shape and may comprise two identical sections 17 and 18. Sections 17 and 18 are releasably fastened together (see FIG. 4). Pump inlet 14 and conduit 13 are placed in the hollow interior 22 of body section 18. Section 17 is subsequently fastened to section 18. There is also shown gap or opening 19 between sections 17 and 18. Gap 19 allows entry of water or liquid into hollow interior 22 of body 16. Pump inlet 14 is securely held in place within body 16 when sections 17 and 18 are fastened together.

FIG. 2 is a more detailed side view of body 16 showing the pump inlet 14 of bailing apparatus 10 inside body 16. Body 16 is resting on the bottom of waterhole 8. Pump inlet 14 comprising valve casing 15 and check valve 26 may have a strainer or gauze (not shown). Conduit 13 may be rigidly attached to a side wall of valve casing 15 through a rigid, locking or screw joint 15A. Alternatively conduit 13 can be attached to valve casing 15 using a swivel joint. Gap 19 extends along the length of body 16 in between body sections 17 and 18.

FIG. 2 also shows an alternative attachment location for conduit 13 (conduit 13A). Conduit 13A extends through a suitable aperture (not shown) located in section 17. Conduit 13A may be rigidly attached to a side wall of valve casing 15 through a rigid, locking or screw joint 15B. Alternatively conduit 13A can be attached to valve casing 15 using a swivel joint. In use body 16 is pivotally attached to conduit 13A.

FIG. 3 is an end view of body 16 showing conduit aperture 27 and container fastening sleeves 29.

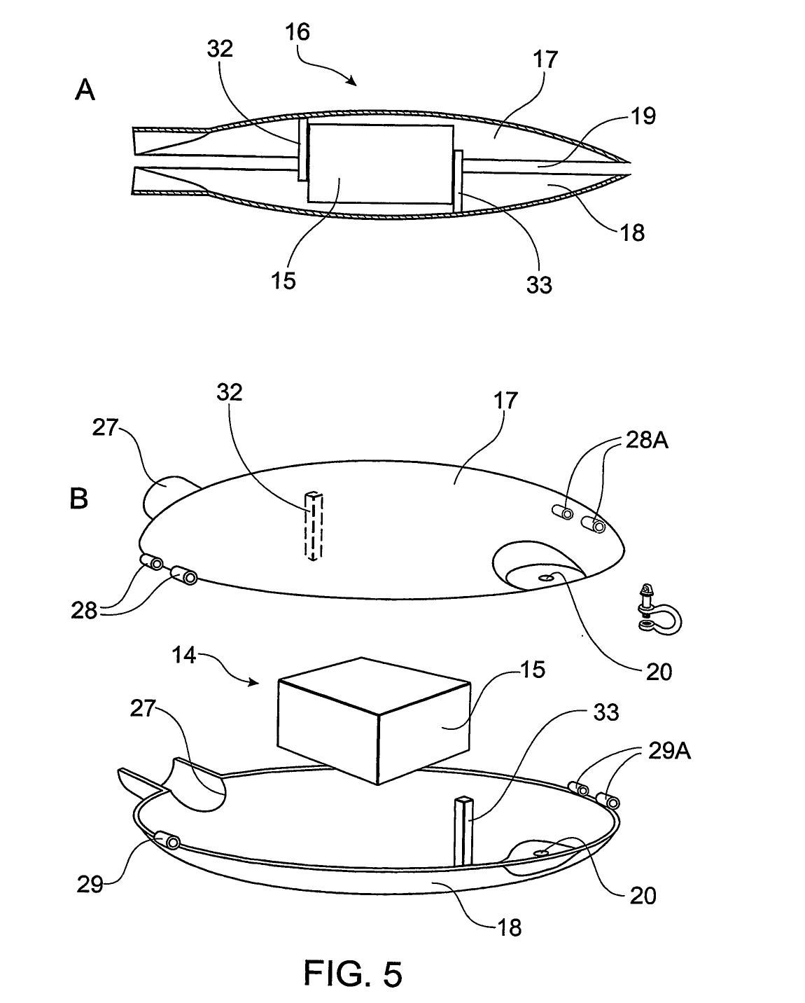

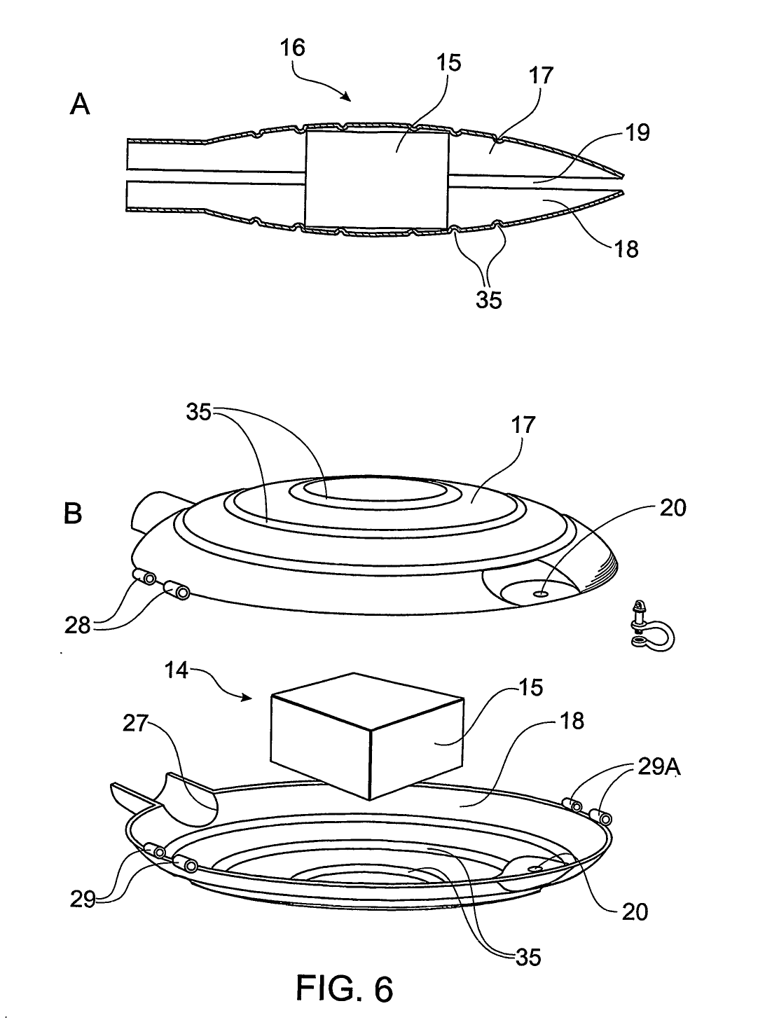

FIG. 4 is a plan view of section 17 of body 16 showing fastening sleeves 29, tether attachment means 20 and conduit aperture 27. Fastening sleeves 28 and 29 are rigidly attached to body 16, such as by welding. At one end sleeves 28 of section 17 mate with a corresponding sleeve 29 of section 18 as shown in FIGS. 5 and 6. At the other end sleeves 28A of section 17 mate with corresponding sleeves 29A of section 18 as also shown in FIGS. 5 and 6. The fastening sleeves are held in place by spring clips 30 and 31.

The interior of sections 17 and 18 may provide retaining means for retaining pump inlet 14 within body 16 (FIGS. 5 and 6). In FIG. 5 upright rods 32 and 33 secures pump inlet 14 in place so it is retained between rods 32 and 33 and the arcuate surface of hollow body 16.

In FIG. 6 retaining ribs 35 and the arcuate surface of hollow body 16 secures pump inlet 14 in place.

The retaining means may also comprise one or a plurality of collars located on an internal surface of body 16.

The operation of bailing apparatus 10 will now be described. Before use of bailing apparatus 10, pump inlet 14 and conduit 13 are placed in hollow interior 22 of body 16. Pump inlet 14 is positioned between retaining ribs 32 and 33. Body sections 17 and 18 are fastened together and secured as described above in FIG. 4. Pump inlet 14 is secured in position between retaining ribs 32 and 33 and the arcuate surface of sections 17 and 18. Body sections 17 and 18 can be releasably attached by any other releasable attachment if desired, such as by interference or use of a clamping device. Gap 19 is maintained by the attachment means. The position of fastening sleeves 28 and 28A and/or 29 and 29A may be moveable so as to allow gap 19 to be adjustable in width. Alternatively, sleeves 28, 28A, 29 or 29A may be replaced by an alternative clamping mechanism to achieve an adjustable width of gap 19.

Conduit 13 is attached to suction pump 12. Body 16 can be attached to pole 4 via tether 21. This attachment facilitates maneuverability and guidance of bailing apparatus 10 when in a water body or waterhole but need not necessarily be attached because maneuverability of hollow body 16 may be achieved by-pushing or pulling conduit 13. This is important in areas where there are obstacles in the waterhole, such as rocks or logs.

In practice the person operating the bailing apparatus may have to be some distance away from the water because of a muddy bank or quick sand. Body 16 of bailing apparatus 10 can be dragged or pushed into a water body or thrown into a water body. The ovoidal shape of body 16 means that the bailing apparatus can be used at any orientation, i.e. it does not matter if body section 17 or 18 is in contact with the water body bed. The ovoidal shape of body 16 also insures that body 16 can be easily maneuvered over the water body bed and does not sink into muddy or silty beds. Furthermore, body 16 can enter the water at any angle because the ovoidal shape of the apparatus and the pivotal attachment of conduit 13 or 13A to body 16 ensure the apparatus will automatically orientate itself as it sinks to rest flat on the bottom of the waterhole.

If conduit 13A is attached to valve casing 15 through the upper wall of section 17 (see FIG. 2), conduit 13A can be used to lower body 16 into a deep water body, such as a well or pot hole. The location of conduit 13A (above body 16) allows greater maneuverability of body 16 in restricted areas, for example, a well.

Hollow body 16 may have a plurality of apertures (27) in different locations for the attachment of conduit or hose 13 or 13A.

Suction pump 12 and collection container (not shown) remain on dry land, or on a boat or other pontoon or raft structure. Water is discharged into the collection container through a discharge conduit (not shown). When assembled body 16 is placed in water in a water body, the person operating bailing apparatus 10 activates suction pump 12. This creates a vacuum in conduit 13 which opens check valve 26 allowing water to enter conduit 13 through the valve orifice. The water is sucked through conduit 13, pumped into the discharge conduit and discharged into a collection container. Suction pump 12 can be any type of pump such as a vacuum pump, hydraulic or rotary pump. Pump inlet 14 can be any type of pump inlet, such as an open hose or a complicated pump inlet strainer. Valve 26 can be any type of check valve, such as a ball, spring, or swing and lift valve. Alternatively, the valve inlet may comprise a venturi device. Conduit 13 can have variable length and width and is preferably made out of any flexible and waterproof material such as plastic, for example, polypropylene or rubber.

Valve casing 15 may comprise a strainer, filter or gauze (not shown) encasing check valve 26 to prevent particles such as stones and weeds entering conduit 13.

When body 16 is placed in water, water enters hollow interior 22 of body 16 through gap 19. The ingressing liquid through gap 19 forms an envelope of liquid around the pump inlet. Preferably, laminar rather than turbulent flow of liquid is produced. The arcuate surface of hollow body 16 plays a role in producing laminar flow of liquid within the hollow body. The arcuate surface prevents turbulence and vortexing of the liquid and this results in increased efficiency in extraction (or pumping) of the liquid.

Gap 19 may comprise a series of spaced openings depending on the specific application. Preferably, gap 19 is an elongate single opening arranged in a row about the mid section or mid part of the ovoidal body which has the greatest diameter.

Preferably, there is a relationship between the capacity of the suction pump or design of check valve 26, the size of gap 19 and the size of body 16. It is not desirable for the capacity of the pump to be too high for the size of the body or the size of gap 19. If the capacity is too high, unwanted turbulence may be created in the pump.

Gap 19 is preferably 10-20 times larger than the external opening (capacity) of the pump inlet. This is required to reduce the velocity of the fluid entering body interior 22 through gap 19. There is also a preferred ratio of the capacity of the pump, area of the external opening(s) of pump inlet 14 and width of gap 19, to prevent unwanted suction of air or contaminants into conduit 13. This avoids creation of turbulence and vortexing.

For example, if a 1-2 inch pump is used the apparatus may have the following dimensions:

Preferably, the radius of body 16 is 0.40-0.85 m, more preferably 0.45-0.55 m.

Preferably, gap 19 is continuous along the centre circumference of container 16 and has a width of 5-30 mm. More preferably, the width is 15-25 mm.

Preferably suction conduit 13 has a diameter of 3-8 cm, more preferably 4-6 cm.

Body 16 can be made out of any suitable material, such as stainless steel, galvanised iron, copper plate or moulded plastic, as long as the material selected is waterproof, durable, and of sufficient weight so that body 16 sinks to the bottom of any body of water or liquid. It is important that body 16 does not float on the surface of the water. Preferably, body 16 can withstand being dragged over rugged terrain and being thrown into rocky areas. It will also be appreciated that body 16 can be made of non metal if used in corrosive environments. Preferably, the weight of body 16 is 6-12 kg.

The shallow ovoidal shape of body 16 aids movement of body 16 across a water body bed and prevents sinking of the container into sticky mud or silt, or tipping over of the apparatus. It will be appreciated that the interior volume of body 16 is widely variable depending on the dimensions of body 16, and gap 19 which will be in turn dependent on the pump size and the application. For example, the volume will be much less if a small apparatus was designed for use in draining a fish tank. Conversely, the volume will be greater if a large apparatus is designed for pumping water out of rivers for irrigation purposes.

It will be appreciated that the present invention is not limited to the extraction of water. The invention can also be used to remove any type of liquid, such as oil or chemicals, from a body of liquid. Thus, for example, oil may be removed from water, or vice versa, or the bailing apparatus of the invention may be used for cleaning up spills of hazardous chemicals. The ratio of the size of body 16, width of gap 19 and capacity of suction pump 11 has to be adjusted when applying the invention to more viscous liquids.

It will also be appreciated by a person skilled in the art that peripheral or radial rings or grooves may be incorporated into body sections 17 and 18 to increase the strength of hollow body 16. This may be useful in the design of a large diameter hollow body for use with larger sized pumps.

Water beds are generally uneven, rocky, muddy or silty and it is important to prevent as far as possible the bailing apparatus becoming trapped in the bottom of the water body. Also, when pumping water for livestock in hot climates it is important to draw cool water from the very bottom of the water body. The apparatus may also be used to extract liquid from the surface of bodies of liquid, for example, if the water is cleaner at the surface than at the bottom of a pool, or if oil is to be extracted from the surface of water. The apparatus can be suspended at a desired depth in the liquid using a float or other suspension means.

The invention as shown in the preferred embodiment has the following advantages and uses:

1. the apparatus can be used to extract the last few litres of water from any water body;

2. the apparatus can be used in muddy or silty water bodies which can also be infested with weeds, sludge or any problem material;

3. the apparatus can be easily transported across a water body containing very little water to areas containing valuable water pools;

4. the apparatus sinks to the bottom of any water body thereby pumping cool water from the bottom of the water body.

5. the apparatus is inexpensive to manufacture and the body can be attached to any suction pump to enable extraction of any liquid from shallow pools or any type of water body;

6. the apparatus has a wide range of uses and can be used for removing liquid from flooded areas such as homes, boats, mines, collieries and civil engineering and building sites;

7. the apparatus can be suspended to extract liquid from the surface or upper regions of a liquid body;

8. the apparatus improves efficiency of pumping liquid by providing a laminar flow of ingressing liquid preventing turbulence and vortexing of the liquid;

9. the apparatus allows pumping to commence immediately when in contact with liquid;

10. the apparatus is simple to use and can be operated by one person;

11. the apparatus is portable, does not require connection to mains electricity and can be transported to remote areas;

12. the apparatus is durable and can withstand rugged terrain;

13. the invention offers greater safety to operators; and

14. the invention is not limited to extracting liquid but can also be used for removing powders or grains.

1. An apparatus for removing liquid from a body of liquid, said apparatus comprising a hollow body having a substantially spheroidal or ovoidal shape which in use retains a pump inlet within an interior of the hollow body, the hollow body having one or more openings for ingress of liquid.

2. The apparatus of claim of claim 1 wherein the openings are located at a circumferential portion of mid section of the hollow body.

3. The apparatus of claim 1 wherein the hollow body in cross section has an elliptical shape.

4. The apparatus of claim 1 wherein the hollow body is nonfloatable.

5. The apparatus of claim 1 wherein one or more openings in the hollow body comprise a plurality of spaced openings, which are arranged in a row about the mid section or mid part of the hollow body which has the greatest diameter.

6. The apparatus of claim 1 wherein there is a single elongate opening in the hollow body about its central diameter.

7. The apparatus of claim 6 wherein the opening is adjustable in width.

8. The apparatus of claim 1 wherein the hollow body is comprised of two or more components which are releasably attached to each other.

9. The apparatus of claim 9 wherein the hollow body is comprised of two half or semi-components which are attached to each other about the mid section or area of greatest diameter.

10. The apparatus of claim 9 wherein one component is hingedly attached to the other component at adjacent respective ends of each component.

11. The apparatus of claim 1 wherein the hollow body has retaining means which in use retains the pump inlet within the hollow body.

12. The apparatus of claim 11 wherein the retaining means is a plurality of upright rods attached to an internal surface of the hollow body.

13. The apparatus of claim 11 wherein the retaining means is one of a plurality of peripheral ribs located on an internal surface of the hollow body surrounding the pump inlet in use.

14. The apparatus of claim 1 wherein the hollow body is provided with an attachment means for attaching a tether.

15. The apparatus of claim 1 which also includes the pump inlet.

16. The apparatus as claimed in claim 15 wherein the pump inlet includes a hollow valve casing having a non-return valve or check valve.

17. The apparatus as claimed in claim 15 wherein the pump inlet in use is in flow communication with a pump located externally of the body of liquid.

18. The apparatus as claimed in claim 15 wherein the pump inlet is connectable to the pump by a hose.

19. The apparatus as claimed in claim 18 wherein the hose is pivotally attached to the hollow body.

20. The apparatus as claimed in claim 17 wherein the pump is located on dry land or a pontoon or raft structure.

21. The apparatus as claimed in claim 18 wherein the hollow body is provided with one or a plurality of hose apertures.

22. The apparatus of claim 1 wherein the pump inlet is protected by a strainer or gauze to prevent particulate matter entering the pump inlet.

23. An apparatus for removing liquid from a body of water, said apparatus comprising a hollow body which in use retains a pump inlet within the hollow body, the hollow body having one or more openings for ingress of liquid and comprising at least two components releasably attached to each other, wherein the one or more openings are located at a junction between said at least two components.
